(19) United States
(12) Patent Application Publication
(10) Pub. No.: US 2021/0256608 A1
(43) Pub. Date: Aug. 19, 2021

(54) METHOD AND SYSTEM UTILIZING ARTIFICIAL INTELLIGENCE AN OPTIMIZATION THEORY FOR ASSET MANAGEMENT IN A MANAGER ALLOCATOR PLATFORM

(71) Applicant: Michael William Kotarinos, Palm Harbor, FL (US)

(72) Inventor: Michael William Kotarinos, Palm Harbor, FL (US)

(21) Appl. No.: 16/790,291

(22) Filed: Feb. 13, 2020

(51) Int. Cl. G06Q 40/06; G06F 16/28; G06F 16/2453; G06F 16/22; G06F 17/18; G06N 20/00

(52) U.S. Cl. CPC G06Q 40/06; G06F 16/284; G06N 20/00; G06F 16/2237; G06F 17/18; G06F 16/2453

(57) ABSTRACT

Artificial intelligence and optimization theory in an asset management process to develop a platform for the automated management of money managers in a portfolio construction process. The present innovation includes the process of connecting databases of securities information to asset manager information to create a linked database of information for the overview and management of portfolios. This linked database is then analyzed using a statistical optimization procedure, converted into a series of metrics and compressed and represented by a series of contrasts. These contrasts are analyzed using Data Shapley, Statistical Cointegration and a Democratized Digital Voter System to construct a utility function estimation. This estimated utility is typically high-dimensional in nature and is not always analytically solvable. In order to determine an optimum allocation convex hull optimization processes are run across the function to determine the appropriate weights to assign to each money manager. Once an allocation is made to money managers, money manager and portfolio performance is tracked over time in order to make a determination if reallocation is necessary.

### FIELD OF THE INVENTION

The present invention relates generally to a system for administering artificial intelligence and optimization theory in an asset management process to develop a platform for the automated management of asset managers in a portfolio construction process.

### BACKGROUND OF THE INVENTION

Investment institutions, financial planners and asset management groups often sub-contract all or parts of the management of a portfolio to money managers. These money managers are typically specialists who are familiar with a certain market sector or market segment. For example, a portfolio may consist of a position in emerging markets that is subcontracted to different money managers responsible for different components. For example, one money manager may manage Brazilian assets, another manager may manage Chinese assets, another manager handles Ecuadorian assets and a fourth money manager handles South African assets. In this relationship, a portfolio manager is responsible for the entire portfolio, and the money managers are responsible for managing smaller segment of the portfolio through subcontracting.

The typical process for this is as follows: a financial planner meets with a client and determines a general mix of assets that meets the client's needs. For example, 60% of the portfolio may be invested in equities and 40% in fixed income instruments. From this 60% in equities 10% may be invested in emerging markets. The 10% invested in emerging markets could be split among Brazil, China, Ecuador, and South Africa with a different money manager managing each country. This portfolio's emerging market equity allocation would thus be managed by 4 different money managers. This process is repeated for the rest of the portfolio's allocation. In the end, the final portfolio is the result of the individual transactions and assets overseen by numerous managers.

There are several difficulties with the multi-manager approach. While each individual money manager may appear to be a reasonable manager of assets, in the modern portfolio theory, the real concern pertains to the performance of the particular manager and the performance of the overall portfolio. For example, a portfolio manager may want to create a portfolio with a low level of risk, and even though each money manager's individual allocations may appear to be low risk when they are combined the portfolio is poorly hedged. In this example, using the right mix of moderate-risk portfolio managers may result in a portfolio with lower expected risk and higher expected return.

Another issue in money management is the fee structure. Different money managers charge different fees, and some have a “breakpoint” fee structure. In this breakpoint system, different fees are charged based on the amount of assets placed under management. By allocating more assets to a particular money manager the fee basis may increase. As such, the resulting fee structure and allocation decision for all of the portfolio manager's clients may resemble a step function and have discontinuities. This also creates an issue of how to properly manage multiple client portfolios. Selecting many money managers may be a better fit for each individual client as each client will get a more suitable portfolio, but because this would result in a globally higher fee basis for each client (because the firm would not be able to take advantage of these breakpoint fee discounts) this will result in each client on average paying higher fees. As such, there is an inherent trade-off between fees and suitability with each individual client and a global trade-off between fees, suitability, and client-specific versus firm-specific optimization (that is, to customize more for each client with more money managers or use fewer money managers and lower each client's fee basis) at the firm level.

One of the most critical innovations for dealing with the time-varying structure of data over time is cointegration. Cointegration provides a tool for comparing the relationships between variables over time to try to determine causal relationships (Granger, C W J. “Developments in the study of cointegrated economic variables.” Oxford Bulletin of economics and statistics 48.3 (1986): 213-228.). This has traditionally been used as a form of causal determination in econometrics. In our proposed innovation, this is extended for use with constructed contrasts. This is combined with Markov Chain Monte Carlo, which allows for simulation and inference on high-dimensional spaces with a modification to the Monte Carlo procedure (Geyer, Charles J. “Practical Markov Chain Monte Carlo.” Statistical science (1992): 473-483.).

The above approaches are useful methods, but practical methods to assess robustness are still needed for a successful application. Data Shapley approaches, which are used to make inferences regarding the most important kinds of data, provide a useful technique for addressing these concerns (Ghorbani, Amirata, and James Zou. “Data Shapley: Equitable Valuation of Data for Machine Learning.” arXiv preprint arXiv:1904.02868 (2019).). This process aims to use the ideas from Shapley's approach in game theory to a data-rich environment to draw conclusions regarding the most important information in an implemented process, which can be extended (such as done in this innovation) to determine the most robust process with respect to performance of a complex system.

There are a variety of methods that have been developed to optimize a given process in search of a solution. For example, DANTZIG (https://apps.dtic.mil/dtic/tr/fulltext/u2/a182708.pdf) found the simplex method to be a very powerful tool for linear optimization that expands on the previous work of Fourier. This approach can also be generalized to work under linear constraints, which are important in many applied problems as there are often additional criteria or conditions to take into consideration (DANTZIG, http://www1.cmc.edu/pages/faculty/MONeill/math188/papers/dantzig2.pdf). However, one important issue is that these approaches can take quite a long time to run and can be computationally intensive. Karmakar developed a polynomial-time approach to this process which allows for rapid approximation of interior-point solutions in a feasible timeframe (KARMAKAR https://signallake.com/innovation/karmarkarMay84.pdf). These ideas later served as the foundation for methods such as linear complementary optimization problems (Carlton Lemke. Bimatrix Equilibrium Points and Mathematical Programming. Management Science, INFORMS, 1965, 11 (7), pp.681-689).

U.S. Pat. No. 10,460,379 focuses on a platform for online financial planning tools. This patent primarily focuses on tools relating to budgeting, spending tracking, and other services primarily aimed at small business and consumers. It does not explicitly develop methods and analytical systems for subcontracting, management of complex and non-linear assets, and the management of illiquid assets which are all innovative processes and methods in our proposed platform.

U.S. Pat. No. 10,223,749 relates to tools for a retirement planning platform. This involves estimating whether a client is making sufficient contributions to meet future expected payouts for retirement. This patent is more actuarial in its construction and as such the resulting platform is performing many actuarial computations, rather than machine learning and artificial intelligence based on dynamic computations. As such, the proposed innovation differs in scope and purpose.

U.S. Pat. No. 10,492,059 focuses on a mobile trading platform. The technology in this proposed innovation is cloud-based and focuses on servers, rather than mobile processors. The '059 Patent is directed toward mobile computing devices. Mobile computing devices tend to use different processors than desktops and servers. Mobile devices tend to be smaller in nature and have battery restrictions. As such, they tend to rely on smaller and less power efficient processors. Server processors are impractical as they tend to be too large to effectively work in a small mobile device and have high power usage, even if they are relatively more power efficient. They are also designed to perforin many more operations per second and work with different motherboards that are not designed for mobile use. As such, there are inherent hardware differences between the current invention and what is disclosed in the '059 Patent.

U.S. Pat. No. 8,694,402 focuses on volatility minimization using indexes. The '402 Patent involves a more narrowly defined optimization procedure than utilized in the present invention (volatility, rather than suitability). In the proposed innovation, volatility is a single parameter of interest that is considered on a multi-dimensional frontier. As such, there is a higher dimensional representation in the proposed innovation. The proposed innovation differs in terms of implementation, the types of portfolios that are created, and the way in which assets are managed. Specifically, the proposed innovation contains many aspects of active asset management while index usage, even when used in mixtures, often is associated with passive asset management. Similarly, U.S. Pat. Nos. 8,712,898 and 8,725,624 contains many aspects focusing on indexes rather than asset managers.

As shown, there is a need for a more dynamic, unique, and customizable benchmark metric that is not as constrained, which is achievable through convex hull optimization.

### SUMMARY OF THE INVENTION

The present innovation addresses the problem of managing numerous money managers with the creation of a virtual money manager platform. This platform serves as a virtual manager of different types of money managers and makes allocations for each client to the various money managers. It takes as an input all the data available from exchanges and data providers on various assets such as stocks, bonds, and exchange traded derivatives. It combines this with user-supplied fee and breakpoint structures (these may vary between firms and banks), the money manager's current positions, and the money manager's historical performance (if available). A 9-step computer logic, strategic process is employed in the present invention to construct a desired portfolio. The steps are:

1. Construct a database consisting of various securities including prices and corporate filings.

2. Link the securities database to the money manager database on a platform.

3. Convert the securities and manager information into a series of metrics.

4. Compress the metric data to create a compact vector space version of trade-offs.

5. Using an analytical optimization process to create a weighting system for evaluating the value of one criterion versus another criteria for a given user.

6. Use the weighting system to create a weighted representation of preferences for each individual user.

7. Use a convex hull optimization search process to find the optimal mix of money managers for each portfolio that is in the parameter space.

8. Contract with each money manager on the platform for a given allocation of the portfolio for the client.

9. Use Data Shapley methods to develop a set of rules for automated rebalancing of the money manager allocation.

### BRIEF DESCRIPTION OF THE DRAWINGS

Certain embodiments are disclosed with reference to the following drawings.

FIG. 1 illustrates a block diagram representation of an example of the virtual money manager;

FIG. 2 illustrates the traditional as set management application of the prior art;

FIG. 3 illustrates the approach of a system utilizing artificial intelligence and optimization theory for asset management in an allocator platform;

FIG. 4 illustrates a block diagram of an example of the contrast evaluation system.

### DETAILED DESCRIPTION OF THE PREFERRED EMBODIMENTS

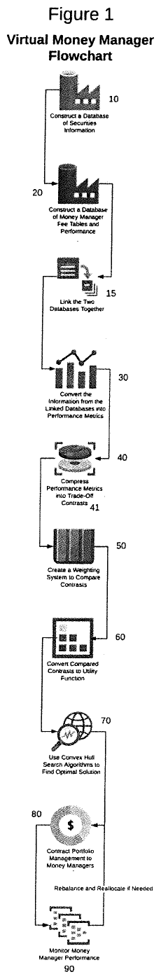

An overview of this process can be seen in FIG. 1.

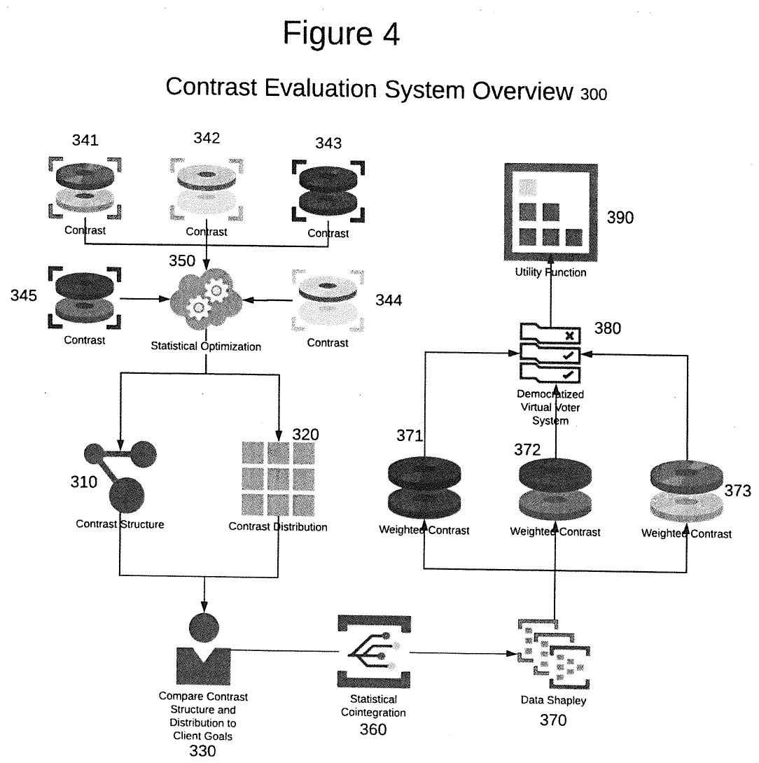

A flowchart of the virtual money manager platform is depicted in FIG. 1. In step 1, a database 10 is constructed with relevant information regarding securities. This will include operational metrics, trading data, and relevant information for the selection of suitable assets for a client. In step 2, a database 20 is constructed regarding the fee structures for money managers. This will typically be in the form of a table that includes breakpoints (where money managers lower their effective fee rate) and fee structure. Also, in step 2, these two databases are linked together 15. This information is consolidated in the next two steps. In Step 3, this information is consolidated into key performance metrics by the conversion processor 30 and in step 4, the compression process 40, is restructured as a contrast 41. Step 5 involves converting these contrasts into a utility function estimation using a weighting process 50. Details regarding Step 5 can be seen in FIG. 4. In step 6, this utility function 60 is structured to match the individual's preferences. This function is then used in step 7 in a convex hull search process 70. This involves searching through the functional representation for an optimal allocation weight. Once a desirable weight is found, the actual subcontracting process 80 occurs in step 8. The final portfolio allocation is monitored 90, and if changes must be made the correction occurs in step 9.

As shown in FIG. 1, the first step in the Virtual Money Manager System Utilizing a Computer Implemented Processing System 10 provides constructing a database of assets 15 such as securities information, real-time market prices and corporate filings issued with the appropriate regulatory body (in the United States typically the Securities and Exchange commission (SEC)). This process typically involves connecting to an application programming interface (API) provided by a third-party data provider, which is often an exchange. Real-time securities quotes by an exchange are typically limited by the speed of one's internet connection and the nature of one's contract with the exchange. Regulatory filings contain information about the asset that can be used to calculate commonly used financial ratios. For example, using debt outstanding and equity issued one can calculate the debt to equity ratio. Commonly used ratios are often calculated and provided by the API provider directly. Data from these filings is typically quarterly.

In some ratios, this data is combined with real-time prices, such as in the price to earnings ratio. As such, the data combination from multiple streams can often involve measures that are non-stationary and tend to jump as new releases become available. As an example, the price to earnings ratio will use the previous quarter's earnings until a new earnings number is released, causing a jump discontinuity to occur. Most portfolios will feature primarily stocks and bonds, although some portfolios with other assets such as derivatives, currencies, and alternative investments such as cryptocurrencies may be used.

The creation of a second database 20 also involves connecting 15 the database of assets 10 to a database of money managers 25 on a platform. In a typical set-up, brokers will have various money managers approved to manage parts of an individual portfolio. For example, a large broker may subcontract the emerging markets part of an equity portfolio. This may involve using one money manager for Brazil, one for Argentina, one for the rest of Latin America, two for Africa, three for China and one for the rest of Asia. These may be chosen out of a list of 300 or so approved subcontractors. This is often done in a qualitative process, rather than quantitatively, and at the end some quantitative metrics are run for an idea regarding the general structure of the portfolio. The present invention quantitative analysis process addresses this problem from inception. In order to do so, information must be collated and assessed for the money managers on the platform. This firm involves inputting fee structures and schedules for the money managers 15. Different money managers charge different fees, and some offer discounts for putting more money under management. One money manager may have a better performance but charge a higher fee. The varying fee structure as a function of the global amount under management for all clients creates complications, as this creates breakpoints and cutoffs that mean using some managers may result in a portfolio that is optimal for a client but sub-optimal for all clients. In order to address this, Gibbs sampling algorithms and other Markov Chain Monte Carlo algorithms can be run sequentially in a cloud computing environment to converge to a stable solution. It can be assumed that most of the money manager's current positions can be seen at a given time. In addition, some information can be gathered regarding their performance over time.

The virtual money manager system 1 employs a conversion processor or system 30 having instructions to convert information regarding the database of assets 10 and database of money managers 15 into key metrics. Assessing the suitability of a money manager in the database of money managers 15 can be considered as determining the appropriateness of the money manager's current positions and the historical attributes of the money manager 15, such as a measure of performance. Performance calculations can be misleading, as a money manager 15 may outperform in some markets and do worse in other markets, and the ideal final allocation should aim to have money managers that together operate in synchronization to manage risk. The conversion process may be performed by combining traditional metrics such as time series predicted performances with new innovative techniques such as methods based on a non-homogenous Poisson process. Each portfolio manager can be assessed based on traditional suitability of positions as they relate to the client with these new innovative financial metrics that measure time-varying characteristics of the portfolio. This allows for the conversion of large amounts of information into several key metrics and pieces of data that can be passed through an artificial intelligence system.

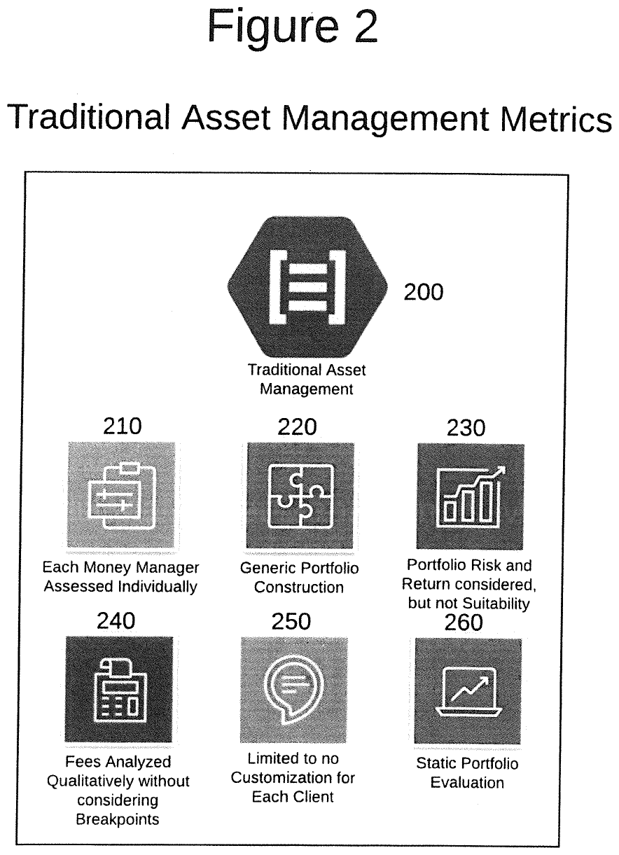

FIG. 2 shows the prior art implementation of the tradition asset management system. In a traditional asset manager environment 200, each money manager is assessed qualitatively. In the proposed innovation, a non-homogenous Poisson process approach is used to dynamically evaluate each money manager 210 over time. This allows for the evaluation of how the money manager performs relative to expected benchmarks to allow the portfolio manager to know if a subcontracted manager should be replaced or given a different weight. In a traditional asset management environment portfolios 220 that are constructed tend to be generic. In the traditional asset management 200, the portfolio risk and return 220 may be analyzed but not suitability. Fees may be analyzed quantitively 240 and the system has no real customization 250 for each individual client. Thus, there is a static portfolio evaluation 260. Examples include “60-40” stock-bond weighted portfolio, long-short company exposure investments, and portfolios 220 meant to broadly follow the larger stock market with some modification.

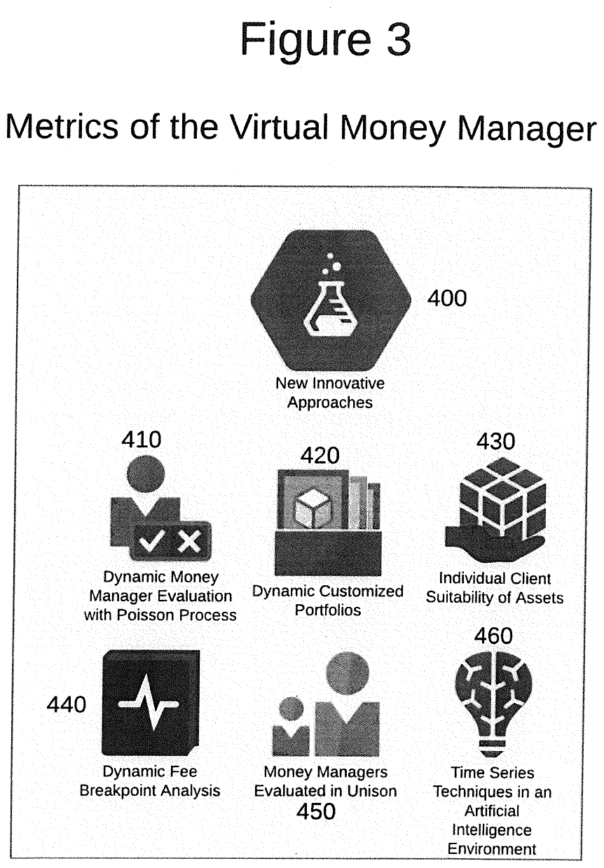

FIG. 3 shows the metrics of the virtual money manager 400 of the present invention. As opposed to the prior art system 200, the virtual money manager 400 operates such that the portfolios constructed are dynamic and meet the unique needs of individual investors. Rather than have portfolios that focus solely on risk and return, these portfolios focus on a wide range of suitability factors. The virtual money manager system 400 operates to provide dynamic money manager evaluation 410 using Poisson Process. The portfolios 420 are dynamic and customized in real time. The individual client suitability 430 for particular assets 11 are measured, considered and implemented. For example, the portfolio might have heavier exposure to emerging markets, provide steady income and meet the needs of someone looking to retire in 10 years. One of the challenges in many money manager systems is how to manage breakpoint fees 440. In this structure, the money manager lowers his or her fee basis as the amount of money under management increases at certain breakpoints. For example, after $1,000,000 invested the money manager may cut his fee in half on additional money invested after the first million dollars. This is a breakpoint fee at $1,000,000. In most systems, these breakpoints 440 are evaluated qualitatively across managers, as it can be difficult to assess many breakpoints for numerous clients across hundreds or thousands of money managers. The convex hull search process provides an analytic approach to address this breakpoint problem allowing for dynamic breakpoint fee management. Each of the resulting portfolios is customized to each client 420, which provides a significant value addition in our proposed innovation. Since many portfolio managers have hundreds of clients and hundreds of money managers 450, customizing each client portfolio and asset exposure can be extremely difficult and impractical in a traditional financial system. In the proposed innovation, the use of artificial intelligence 460 to make dynamic predictions 410 allows for the customization of portfolios for each client. Rather than evaluating portfolios statically at a single point in time, the proposed innovation uses artificial intelligence and time series-based techniques 460 to dynamically monitor portfolios in real-time over different time periods. The end result is constant monitoring and adjustment to money manager allocations as market conditions change. The integration and combination of all of these innovative practices together provides a powerful package of methods in the proposed platform.

The compression process 40 involves compressing the key metrics and information from the conversion processor 30 into a compact vector space to allow for creating a set of possible trade-offs. This involves transforming the data collected into a series of contrasts 41. Contrasts 41 are tools used in experimental design that represent key features in a study or experiment. In this case, the contrasts are a mix of traditional financial trade-offs and some new innovations. For example, traditional trade-offs include “risk versus return” and “growth versus value,” among others. Trading off risk and return means that some assets 11 from the database of assets 10 may have a higher expected return, but as such expose the client to a higher degree of risk. Similarly, stocks with high growth prospects may have weaker balance sheets and lower free cash flow, and as such may not represent as strong of a value for investors for strong immediate performance on key metrics. The result is that large troves of information are vectorized into a contrast system. As such, the problem becomes reduced in dimension from making a decision over a high number of vectors to choosing between a set of contrasts 41.

The weighting system 50 functions to compare the contrasts 41. The proposed innovation introduces the innovative approach for making a decision among the constructed contrasts 41. The analytical process of the present invention is run on the different contrasts 41 to make statistical determinations of the structure and distribution of the elements. These are then compared to a stated client's goals and processed to make a determination on how heavily to weight one contrast versus another and if contrasts are heavily related. The weighting system 50 implements a computer processor operating a set of instruction to combine the analytical method with statistical cointegration to determine relationships over time, analyze trends in the data, and compare these trends to stated goals and desires of the clients. The weighting system 50 combines the analytical method with cointegration not alone sufficient. Thus, the system 50 must analyze the contrasts 41 using Data Shapley to determine the most important information to analyze for robustness and consistency. This is because while these are statistically sound practices the model still needs to be tested to ensure it is sound and valid. For example, the given preferences after analysis can be found to be inconsistent or outside of the parameter space. An individual may want a high growth stock at a cheap price with a very high dividend yield, but this stock may not exist and would be an example of a solution outside of the available parameter space. Further, the way the information is worded or posed may lead to inconsistent or intransitive preferences. An individual may seem to want a value stock because of the way a question is worded but may actually prefer growth stocks. The weighting system 50 tests the stated preferences based on questionnaires and other information gathered. The weighting system 50 processes a mix of natural language processing against red flags for possible signs of inconsistencies. If a possible red flag is found, the process can be decomposed using Data Shapley and a Democratized Virtual Voter System (DVVS) to make a determination if this red flag would have a material effect on the portfolio construction. If it would not, then the chosen preference structure can be used. If not, the portfolio manager should follow up with the client, obtain the suggested information from the Data Shapley and DMMS system and then re-run the proposed innovative process.

An overview of this can be seen in FIG. 4.

FIG. 4 provides an overview of the process from turning a series of contrasts into a utility function. In the first step, the contrasts 341, 342, 343, 344 and 345 are run through a statistical optimization process 350 to determine vital components of the contrast structure and contrast distribution. The structure 310 and distribution 320 of these contrasts 341, 342, 343, 344 and 345 are then compared 330 to the investment goals of the client. In order to determine the most important contrasts that drive client suitability and portfolio performance, statistical cointegration 360 is performed to determine what contrasts 341-345 play the most important role over time. These contrasts 341-345 are passed through a Data Shapley system 370 to construct weighted contrasts 371, 372 and 373. These weighted contrasts 371, 372 and 373 have an additional weight dimension added, which describe their relative importance to a client. Finally, if there are multiple clients or esults that warrant further investigation these results are passed through a democratized virtual voter system 380. This is a system designed to investigate material differences among contrasts and ascertain the most important factors and whether any factors warrant further investigation. Once this process is complete the end result is a utility function representation 390 of a client's preferences. This utility function 390 allows for a framework for selecting money managers.

In the consolidating process 60 operates to consolidate the optimized response selections into an estimated utility function 61 for the client. A utility function 61 is a rank ordering of preferences that allows one to determine how much one factor is valued versus another. In this money manager system, it allows for the specification of how to combine various factors together to select money managers. For example, it could show that for a client very concerned about fees that a more standard investment instrument such as an exchange traded fund (ETF) with a limited number of positions managed by money managers may be more appropriate than numerous positions managed by money managers when there are ETF equivalents. Similarly, such a system will allow for evaluating other factors such as how the portfolio should be structured, how suitable each position needs to be versus the global suitability of the portfolio, and the tolerance between switching between portfolio managers among other criteria. This represents a multi-dimensional Pareto frontier, rather than the traditional two-dimensional Pareto frontier of risk versus return that is traditionally used. As such, this innovation represents a significant advancement in the fundamentals of asset management as it incorporates complex ideas from the frontiers of experimental design, mathematical finance, and regulatory asset compliance.

A convex hull optimization search 70 may be implemented to find the optimal mix of money managers based on the utility function 61 from the consolidation process 60. At this point in the process, an estimated utility function 61 is available for a client and in lower dimensional representations it can be computationally straightforward to determine the optimal mix. One of the dynamic features of the present invention is the high-dimensional utility representation that captures additional aspects of preferences beyond just risk and return. Because of this, it can be difficult to find the optimal allocation. This is because the form of the utility function 61 can be quite complex and difficult to solve analytically. Furthermore, high dimensional spaces are typically not estimable with standard Monte Carlo simulation. As such, Markov Chain Monte Carlo with a cloud computing infrastructure is run in a convex hull a optimization search 70 process to determine a suitable mix of money managers. The convey hull optimization process uses a mix of established optimization algorithms from computer science with Markov Chain Monte Carlo techniques to search and estimate the ideal mix. The result is an allocation represented as a vector with a number between 0 and 1 for each money manager which collectively sums to 1 representing the percentage of the portfolio allocated to each money manager. For example, in the case of five money managers the vector may represent the numbers 0, 0.2, 0.4, 0.4, and 0 which would mean the first and fifth money managers would manage none of the portfolio, the second money manager would manage 20% of the portfolio and the third and fourth money manager would manage 40% each.

The contract portfolio management step 80 involves the process of subcontracting the portfolio to each money manager. In this step, each money manager is assigned the aforementioned percentage of the portfolio to manage. The results from the money manager's performance are monitored over time and used to update the expected performance metrics of the money manager by comparing it to the performance of the market, other money managers, and similar investment allocations such as the performance of an ETF with a similar exposure to that of the money manager's investments.

The results collected in the contract portfolio management step 80 are monitored 90 with Data Shapley techniques 91 to determine if the money manager allocation should be changed. This rebalancing of money managers can occur due to market conditions, a change in investment desire expressed by the client, or by money managers underperforming or overperforming. As changes are warranted the money manager allocation will dynamically change to reflect change conditions.

This aforementioned process in broad in its design and can be used and implemented across systems to address specific agency problems. The general structure of the system is broad, flexible, and has applications beyond traditional asset management into areas such as engineering, manufacturing, product development, and pharmaceuticals.

One example application of the proposed innovation is for the management of commodities. Commodities data and prices can be constructed by combining information from exchanges and data providers. For example, generic commodity information can be combined with specialized information from smaller exchanges, such as specialty markets. For each of these commodities, the subcontracting of the individual commodity components can be managed using the aforementioned nine step process. This process can also be used for management of hard assets such as real estate and oil wells.

For the process of managing oil wells the process relies on slight changes to the database structure. Yet again, several different databases are connected and converted to manage the process and the data needs to be streamlined and reformatted. Exchange data is used to track oil commodities prices. Individual oil wells are monitored from data from a third-party data provider such as Bloomberg. This data is then combined with real-time satellite data using machine learning to parse the data. For example, machine learning can be used to determine the amount of oil held in oil containers based on satellite readings fed into a machine learning algorithm. This process results in a large database which reveals key underlying trends and metrics in oil wells. This can be used to dynamically monitor these assets and assess how well money managers are performing in the oil industry based on a customized benchmark. For example, traditional metrics might suggest a certain money manager is overperforming or underperforming by considering the entire oil market as a single market. In reality the market is made up of many individual and connected markets such as crude oils, shale, and refineries. Being able to assess the relationship of the money manager's exposure to these various components and the timing of the exposure can allow for a more accurate measurement of risk. The aforementioned process for oil can also be repeated for real estate. Just as oil is made up of many submarkets, real estate is composed of various submarkets as well. For example, the real estate market could be subdivided by regions. Each region can further be divided into cities, and each city can be further divided into submarkets such as commercial and residential real estate. As such, this allows for dynamic monitoring and assessment of real estate money managers and dynamic benchmarking for their investment choices. This could also be tailored to allow for dynamic Real Estate Investment Trust (REIT) construction.

Database linkages and creation can also be done to connect this information to a system for manufacturing and production. For any product, there are many manufacturing contractors and agencies that aid in the production and market development of a product. In the proposed framework, these could be considered managing part of a portfolio, where the entire product is considered a portfolio that can generate a return and part of the portfolio is the marketing and production of the asset. One of the reasons why this is atypical is because each stage of the product cycle is highly correlated to the other stages, which makes measuring and optimization difficult. In this framework this is addressed by considering the global optimality of the production mix through a non-linear convex hull optimization process. The proposed innovation thus extends traditional production and manufacturing theory by connecting it to traditional asset management, allowing for the assessment of marketable and production-ready assets along with other assets. This will allow venture capital firms to assess the role more speculative consumer-ready products play in a global asset portfolio of goods such as commodities, REITs, securities (some not publicly traded), and other goods. For example, suppose a venture capitalist invests in a consumer goods manufacturer. This allow the investor to assess the performance of the manager of the manufactured good versus a benchmark estimated performance if the good was sold on a licensing deal, contextualized in terms of the relative level of risk over all the investments. For example, localized production may have a slightly higher expected return but may not be justified when factored into the level of risk taken in other investments in the portfolio. An example of this would be a suggestion to lease out production of a good and take more risk by hiring money managers that engage in more speculative real estate investments. This allows for the assessment of the management of assets across the deprecated lifecycle of the asset and the connection of assets to development and production of other assets. This plays an important role not just in the management of product platforms but for firms regularly engaged in mergers, acquisitions, and spinoffs as the aforementioned firms often view their products as a large portfolio rather than single market-driven products.

One particular application of note is the development of pharmaceuticals. Pharmaceutical development begins in the research of chemical compounds and crystallization structures of chemicals. Promising chemical compounds are analyzed and synthesized by connecting a chemical structure to a delivery mechanism. These are then developed into a potential pharmaceutical drug and placed through clinical trials, subject to regulatory approval. Each of these steps in the process can be considered subcontracted management, as a single entity typically does not perform all of these steps. For example, in a typical product cycle a university will research potential chemical structures, often through a chemistry, physics, or pharmacokinetics department. The rights to chemical structures with promise are then sold to pharmaceutical developers, who connect the compounds to delivery agents that create potential drugs. These drugs are then researched and trialed on a contract basis with a partnering research hospital. For example, a specialist hospital will aid in and assist with the management of a clinical trial in coordination with biostatisticians at a pharmaceutical developer. At the end, the product will either receive regulatory approval, fail to receive regulatory approval, or the trial will be discontinued before being submitted for regulatory approval. Each step as such is managed by a different entity. For example, it could be found that a certain University provides many chemical compounds that appear useful but often fail regulatory approval, and as such their compounds should be assessed as riskier. A certain hospital may be a low-cost option for running a clinical trial but does not collect and collate very much data beyond the bare minimum for a clinical trial. As such, a high proportion of the drugs studied at their hospital will go through many trials before being subsequently rejected, while another hospital may be more expensive but give better data that allows for the termination of the research on an ineffective compound earlier in the process lifecycle. As such, each of these steps needs to be analyzed and decomposed. Using the nine-step procedure we mentioned in this proposed innovation, the relationships between these different sub managers can be assessed to determine the optimal parties. An example result would suggest primarily using compounds from a certain university and studying them at a certain hospital and making a determination whether or not to continue with the aforementioned trial based on a certain stage in the process. Using this method, an optimal selection of chemical compounds can be chosen, and the risks involved can be hedged based on the use of other assets, such as derivative and insurance contracts.

All of the aforementioned innovations are designed to operate within a cloud computing infrastructure. These innovations are built to operate in real-time in a secured environment with requests originating from different server regions. This allows for scalable, real-time deployments that incorporate and use new data as it becomes available in a flexible environment that connects a front-end user interface system with localized cloud computing back-end instances to return results either through a web portal or application portal interface to end users. The end result is a dynamic, modularized infrastructure that is adaptable, cost efficient and quickly customizable.

What is claimed is:

1. A computer implemented method of managing a virtual money management platform on a system comprising:
a first data storage device consisting of a plurality of assets;
a second data storage device consisting of a plurality of manager information;
a computer implemented logic coupled to the first data storage and the second data storage device, the computer implemented logic processing configured to permit access to and store account data related to the assets and manager information stored in the first data storage and second data storage;
a computer readable medium stored on a processor having instructions which cause the processor to carry out steps comprising:
linking the first database to the second database on a platform;
converting the assets in the first database to a series of asset metric data;
converting the manager information in the second database to a series of manager information metric data;
compressing the asset metric data and the manager info nation metric data to create a compact vector space version of a series of value criterion;
entering a value criteria for a user based on the user preferences;
utilizing an analytical optimization process to create a weighting system for evaluating one of the series of value criterion versus the value criteria of the user;
compiling a weighted representation of preferences for he user using the weighted system; and
using a convex hull optimization search process to general a blend of selected money managers for the portfolio of a user.

2. The computer implemented method of managing a virtual money management platform of claim 1 wherein the assets consist of one or more securities.

3. The computer implemented method of managing a virtual money management platform of claim 2 wherein the securities include a price and a corporate filing information.

4. The computer implemented method of managing a virtual money management platform of claim 3 wherein the money manager information comprises a current position and a historical performance.

5. The computer implemented method of managing a virtual money management platform of claim 4 wherein the value criteria based on user preferences comprises a manager fee information and breakpoint structure information.

6. The computer implemented method of managing a virtual money management platform of claim 1 further comprising the step of:
using one or more Data Shapley methods to develop of a set of rules; and
rebalancing the selected blend of money managers allocated to the portfolio of a user as determined by the set of rules.

7. The computer implemented method of managing a virtual money management platform of claim 1 further comprising the step of contacting the selected money managers for a user portfolio.

8. The computer implemented method of managing a virtual money management platform of claim 6 wherein the asset consists of one or more commodities.

9. The computer implemented method of managing a virtual money management platform of claim 6 wherein the assets consists of real estate.

10. The computer implemented method of managing a virtual money management platform of claim 6 further comprising the step of contacting the selected money managers for a user portfolio.

11. The computer implemented method of managing a virtual money management platform of claim 1 further comprising the step of cleaning the assets and manager information in the first database and secured database using machine learning and data analytics.

12. The computer implemented method of managing a virtual money management platform of claim 1 further comprising the step of analyzing a method to allocate capital across a portfolio of selected managers to conform with prerogatives provided by an expressed utility function.

13. The computer implemented method of managing a virtual money management platform of claim 12 further comprising the step of framing the asset metric data to create a compact vector space version of trade-offs.

14. The computer implemented method of managing a virtual money management platform of claim 6 further comprising the step of using statistically optimization to create a weighting system for evaluating the value criterion versus the value criteria of the user.

15. A computer implemented method for determining the optimum platform for selecting money managers in a portfolio construction process, the method comprising:
maintaining an asset database on a server of an asset information;
maintaining money manager database on a server of a plurality of money managers information;
linking by a computing device the asset database to the money manager database;
consolidating the asset information and money manager information into a key performance metrics;
restructuring the key performance metrics of the asset information and money market information as a contrast;
converting the contrasts into utility function estimations;
obtaining a desired preference information from an individual;
structuring the utility function to conform with the desired preference information;
utilizing the utility function in a convex hull search process of the market manager information to determine a functional representation of a desired allocation weight;
and
generating a portfolio of market managers for the individual.

16. A computer implemented method for determining the optimum platform for selecting money managers in a portfolio construction process of claim 15 wherein the assets consist of one or more securities.

17. A computer implemented method for determining the optimum platform for selecting money managers in a portfolio construction process of claim 16 wherein the securities include a price and a corporate filing information.

18. A computer implemented method for determining the optimum platform for selecting money managers in a portfolio construction process of claim 15 further comprising the steps of using one or more Data Shapley methods to develop of a set of rules; and
rebalancing the selected blend of money managers allocated to the portfolio of a user as determined by the set of rules.

19. A computer implemented method for determining the optimum platform for selecting money managers in a portfolio construction process of claim 18 further comprising the step of framing the asset metric data to create a compact vector space version of trade-offs.
